(19) United States
(12) Patent Application Publication
(10) Pub. No.: US 2024/0212244 A1
(43) Pub. Date: Jun. 27, 2024

(54) METHOD AND APPARATUS FOR LEARNING ARTIFICIAL INTELLIGENCE LEARNING MODEL FOR IMAGE RECONSTRUCTION

(71) Applicant: dob Studio, Inc., Seoul (KR)

(72) Inventors: Young Jae JO, Seoul (KR); HyeonWoo SEOL, Goyang-si (KR); Se Ah KWON, Seoul (KR); Ha Yoon PARK, Seoul (KR); Sunggyun Jang, Seoul (KR)

(73) Assignee: dob Studio, Inc., Seoul (KR)

(21) Appl. No.: 18/389,810

(22) Filed: Dec. 20, 2023

(30) Foreign Application Priority Data
Dec. 21, 2022 (KR) 10-2022-0180535
Jun. 13, 2023 (KR) 10-2023-0075846

(51) Int. Cl. G06T 11/60; G06T 5/50; G06T 5/70; G06V 10/25

(52) U.S. Cl. CPC G06T 11/60; G06T 5/50; G06T 5/70; G06V 10/25; G06T 2207/20221

(57) ABSTRACT

Disclosed are a method and an apparatus for learning an artificial intelligence learning model for image reconstruction, wherein the method for learning an artificial intelligence learning model for image reconstruction includes: setting a mask area corresponding to each of a plurality of preset parts to an original image; generating a first image corresponding to a first part among the parts based on an artificial intelligence learning model for generating a reconstructed image; generating a third image by applying a mask for the first part to the first image; calculating a loss function corresponding to a difference between the original image and the third image; and performing learning on an artificial intelligence learning model for outputting a latent code corresponding to the first part by performing back-propagation based on the loss function.

### CROSS-REFERENCE TO RELATED APPLICATION

This application claims priority under 35 USC § 119 to Korean Patent Application Nos. 10-2022-0180535 filed on Dec. 21, 2022, and 10-2023-0075846 filed on Jun. 13, 2023 in the Korean Intellectual Property Office (KIPO), the entire disclosure of which are incorporated herein by reference.

### BACKGROUND OF THE INVENTION

### 1. Field of the Invention

The present invention relates to a method and an apparatus for learning an artificial intelligence learning model for image reconstruction.

### 2. Description of the Related Art

The content described below merely provides background information related to the embodiment according to the present invention and does not constitute the prior art.

Artificial Intelligence (AI) is a field of computer engineering that focuses on solving cognitive problems primarily linked to human intelligence, such as learning, problem solving, and pattern recognition. Especially, a machine learning refers to a collection of algorithms capable of conducting a learning from recorded data to make predictions based thereon, optimizing basic utility functions under uncertainty, extracting hidden structures from the data, and classifying the data as concise descriptions. In further detail, a deep learning is a field of the machine learning that involves layering algorithms to understand data more deeply. The deep learning uses layers of nonlinear algorithms to create interactive and distributed representations based on a set of factors. In addition, after sufficient learning, relationships, which may not be recognized by humans, may be figured out, or problems, which may not be easily solved, may be solved simply. It has already been applied to various fields, such as daily life, medicine and autonomous driving, has achieved many results, and has become one area of irreplaceable technologies.

Generative Adversarial Network (GAN), which is a type of image generation model, have recently been used in various fields. GAN is widely applied in fields other than images, such as voice generation or editing, new drug development and prediction in addition to the main field of image creation and restoration.

However, despite a GAN's generator capable of generating very high-level images, generating images in detail still remains a difficult task. Particularly, GAN inversion for an area having high frequency in relatively narrow areas, such as eyes or teeth, still appears unnatural. Accordingly, a method for training an artificial intelligence learning model is required so that GAN inversion for narrow areas becomes natural.

### SUMMARY OF THE INVENTION

The present invention is provided to train an artificial intelligence learning model for image reconstruction.

In addition, the present invention is provided to combine images output using multiple artificial intelligence learning models to output a reconstructed image.

In order to achieve the above objects, a method for learning an artificial intelligence learning model for image reconstruction according to one embodiment of the present invention includes: setting a mask area corresponding to each of a plurality of preset parts to an original image; generating a first image corresponding to a first part among the parts, based on an artificial intelligence learning model for generating a reconstructed image; generating a third image by applying a mask for the first part to the first image; calculating a loss function corresponding to a difference between the original image and the third image; and performing learning on an artificial intelligence learning model for outputting a latent code corresponding to the first part by performing back-propagation based on the loss function, wherein the artificial intelligence learning model for outputting a latent code may be a first artificial intelligence learning model that receives the original image as input to output a latent code for generating a reconstructed image corresponding to at least one of the parts, and the artificial intelligence learning model for generating a reconstructed image may be a second artificial intelligence learning model that receives the latent code as input to output a reconstructed image.

The setting of the mask area may include: expanding and setting an area for each of the masks so that boundaries subject to division of the original image overlap with each other; and blurring for each of the masks to allow areas, which overlap when the first image is combined according to the expansion, to be naturally combined.

The method may include: outputting, after the setting of the mask area, a latent code for generating a first image reconstructed for each of the parts from the original image based on the first artificial intelligence learning model; generating the first images reconstructed from the latent code for each of the parts based on the second artificial intelligence learning model; and generating a second image reconstructed with respect to the original image by applying the mask to each of the first images generated for each of the parts, and combining the first images to which the mask is applied.

The first artificial intelligence learning model may include a plurality of artificial intelligence learning models that output latent codes for generating reconstructed images for each of the parts. The outputting of the latent code, the generating of the first images, and the performing of the learning on the artificial intelligence learning model may be repeated until a loss value corresponding to a difference between the original image and the first images is decreased to a preset value or less.

The generating of the first images may include generating the first images for each of the parts by adjusting style values for image reconstruction for each of the parts with respect to the original image.

In addition, the apparatus for learning an artificial intelligence learning model for image reconstruction according to one embodiment of the present invention includes: a mask setting unit for setting masks for a plurality of parts of an original image; a first image generation unit for generating a first image corresponding to a first part among the parts; a third image generation unit for generating a third image by applying a mask for the first part to the first image; and an artificial intelligence learning unit for training the artificial intelligence learning model.

The mask setting unit may set a mask area corresponding to each of a plurality of preset parts of the original image, the first image generation unit may generate a first image corresponding to a first part among the parts based on an artificial intelligence learning model for generating a reconstructed image, the third image generation unit may generate a third image by applying a mask for the first part to the first image, the artificial intelligence learning unit may perform learning on an artificial intelligence learning model for outputting a latent code corresponding to the first part by calculating a loss function corresponding to a difference between the original image and the third image and performing back-propagation based on the loss function, the artificial intelligence learning model for outputting a latent code may be a first artificial intelligence learning model that receives the original image as input to output a latent code for generating a reconstructed image corresponding to at least one of the parts, and the artificial intelligence learning model for generating a reconstructed image may be a second artificial intelligence learning model that receives the latent code as input to output a reconstructed image.

The mask setting unit may expand and set an area for each of the masks so that boundaries subject to division of the original image overlap with each other, and blur each of the masks to allow areas, which overlap when the first image is combined according to the expansion, to be naturally combined.

The apparatus further includes: a latent code output unit for outputting a latent code from the original image; a second image generation unit for generating images reconstructed from the latent code; and an image combination unit for combining the reconstructed images, wherein the latent code output unit may output a latent code for generating a first image reconstructed for each of the parts from the original image based on the first artificial intelligence learning model, the second image generation unit may generate the first images reconstructed from the latent code for each of the parts based on the second artificial intelligence learning model, and the image combination unit may generate a second image reconstructed with respect to the original image by applying the mask to each of the first images generated for each of the parts, and combining the first images to which the mask is applied.

The first artificial intelligence learning model may include a plurality of artificial intelligence learning models that output latent codes for generating reconstructed images for each of the parts. The artificial intelligence learning unit may repeatedly learn until a loss value corresponding to a difference between the original image and the first images is decreased to a preset value or less, and the second image generation unit may generate the first images for each of the parts by adjusting style values for image reconstruction for each of the parts with respect to the original image.

According to the present invention, the artificial intelligence learning model for image reconstruction can be trained.

In addition, according to the present invention, images output using multiple artificial intelligence learning models can be combined to output a reconstructed image.

### BRIEF DESCRIPTION OF THE DRAWINGS

FIG. 1 is an operational flow chart showing a method for learning an artificial intelligence learning model for image reconstruction according to one embodiment of the present invention.

FIG. 2 is an operational flow chart showing a method for learning an artificial intelligence learning model for image reconstruction according to one embodiment of the present invention.

FIG. 3 is an operational flow chart showing a method for learning an artificial intelligence learning model for image reconstruction according to one embodiment of the present invention.

FIG. 4 is a view showing the configuration of the apparatus for learning an artificial intelligence learning model for image reconstruction according to one embodiment of the present invention.

FIG. 5 is a view showing the configuration of the apparatus for learning an artificial intelligence learning model for image reconstruction according to one embodiment of the present invention.

FIG. 6 is a view showing a computer system according to one embodiment of the present invention.

FIG. 7 is a view showing a learning process of an artificial intelligence learning model for a specific part according to one embodiment of the present invention.

FIG. 8 is a view showing images output from the model learned by applying learning for each part according to one embodiment of the present invention.

FIG. 9 is a view showing results of generating masks for a plurality of parts according to one embodiment of the present invention.

FIG. 10 is a view showing images output based on original images and an encoder.

FIG. 11 is a view showing enlarged detailed areas of original images and output images.

FIG. 12 is a chart showing results of measuring 10 random sheets of the Celeba Dataset.

FIG. 13 is a chart showing results of measuring 50 random sheets of the Celeba Dataset.

FIG. 14 is a chart showing results of measuring 100 random sheets of the Celeba Dataset.

FIG. 15 is a view showing edited images output according to the editing schemes applied to the encoder.

FIG. 16 is a view showing images output through Restyle_pSp that uses StyleGAN3 as a decoder.

FIG. 17 is a chart showing reconstruction results of Restyle_pSp using the same decoder StyleGAN3 and reconstruction results according to the present invention with targeting 100 random sheets of Celeba Dataset.

FIG. 18 is a view showing original images, synthetic images, and results of combination thereof.

FIG. 19 is a view showing original images and edited images.

### DETAILED DESCRIPTION OF THE INVENTION

The present invention will be described in detail with reference to the accompanying drawings as follows. repeated descriptions and detailed descriptions for known functions and configurations that may unnecessarily obscure the essentials of the invention will be omitted. The embodiments of the present invention are provided in order to more completely describe the present invention to a person having ordinary skill in the art. Accordingly, the shapes and sizes of elements in the drawings may be exaggerated for clearer description.

The terms such as “first”, and “second” are used to describe various components, however, the components are not limited by the above terms. The above terms may be used merely to distinguish one component from the other components. Accordingly, the first components mentioned below may correspond to the second components within the technical idea of the present invention.

Throughout the specification, when a part “includes” a certain component, the above expression does not exclude other elements, but may further include the other elements, unless particularly stated otherwise

Hereinafter, exemplary embodiments according to the present invention will be described in detail with reference to the accompanying drawings.

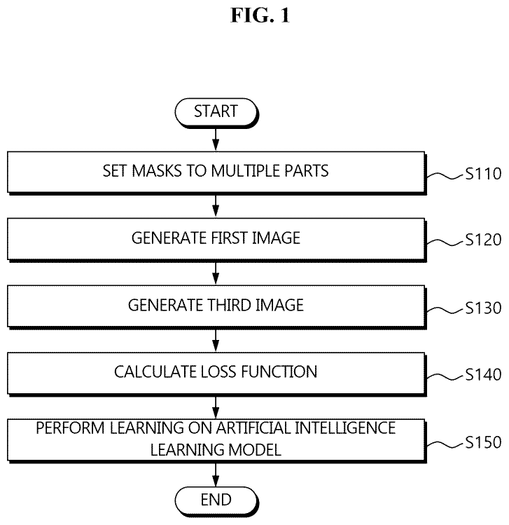

FIG. 1 is an operational flow chart showing a method for learning an artificial intelligence learning model for image reconstruction according to one embodiment of the present invention.

Referring to FIG. 1, in the method for learning an artificial intelligence learning model for image reconstruction according to one embodiment of the present invention, first, a mask area corresponding to each of a plurality of preset parts may be set to an original image (S110).

The mask is required to be divided according to a standard that may not be changed with respect to the original image, and the original image may be divided as much as possible while still having meaning in which a part having pairs may be regarded as an exception and accordingly may not be divided.

Next, a first image corresponding to a first part, which is one of the parts, may be generated based on an artificial intelligence learning model for generating a reconstructed image (S120).

Next, a third image may be generated by applying a mask for the first part to the first image (S130).

Next, a loss function corresponding to a difference between the original image and the third image may be calculated (S140).

Next, learning may be performed on an artificial intelligence learning model for outputting a latent code corresponding to the first part by performing back-propagation based on the loss function (S150).

The artificial intelligence learning model for outputting a latent code may be a first artificial intelligence learning model that receives the original image as input to output a latent code for generating a reconstructed image corresponding to at least one of the parts, and the artificial intelligence learning model for generating a reconstructed image may include a second artificial intelligence learning model that receives the latent code as input to output a reconstructed image.

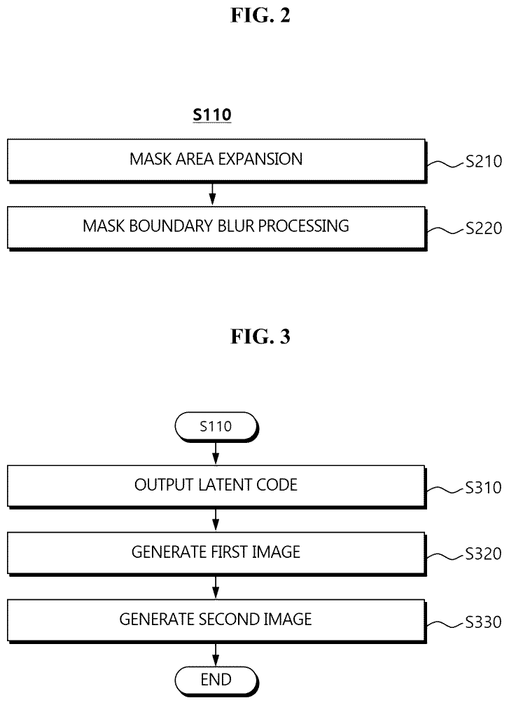

FIG. 2 is an operational flow chart showing a method for learning an artificial intelligence learning model for image reconstruction according to one embodiment of the present invention.

Referring to FIG. 2, in the method for learning an artificial intelligence learning model for image reconstruction according to one embodiment of the present invention, first, an area for each of the masks may be expanded and set so that boundaries subject to division of the original image overlap with each other (S210).

Next, each of the masks may be blurred to allow areas, which overlap when the first image is combined according to the expansion, to be naturally combined (S220).

For example, Gaussian Blur may be applied as a scheme used for the blur processing.

Accordingly, when the output images are combined, the boundary areas of the masks may be naturally combined without artificial artifacts.

FIG. 3 is an operational flow chart showing the method for learning an artificial intelligence learning model for image reconstruction according to one embodiment of the present invention.

Referring to FIG. 3, in the method for learning an artificial intelligence learning model for image reconstruction according to one embodiment of the present invention, a latent code for generating a first image reconstructed for each of the parts from the original image, after the setting of the mask area, may be output based on the first artificial intelligence learning model (S310).

Next, the first images reconstructed from the latent code may be generated for each of the parts based on the second artificial intelligence learning model (S320).

Next, a second image reconstructed with respect to the original image may generated by applying the mask to each of the first images generated for each of the parts, and combining the first images to which the mask is applied (S330).

The first artificial intelligence learning model may include a plurality of artificial intelligence learning models that output latent codes for generating reconstructed images for each of the parts.

According to one embodiment, in step S320, the first images for each of the parts may be generated by adjusting style values for image reconstruction for each of the parts with respect to the original image.

In addition, step S150, step S310 and step S320 may be repeated until a loss value corresponding to a difference between the original image and the first images is decreased to a preset value or less.

The artificial intelligence learning model may be a model that learns through supervised learning using deep learning. The deep learning refers to a technology in which a computer learns by combining and analyzing external data on its own. This is a scheme of using an artificial neural network mimicking the structure of neurons and synapses similar to the human brain for machine learning, and overlapping various neural networks to increase prediction accuracy.

In addition, the supervised learning refers to a learning scheme for training a model using data with predetermined answers and then predicting results for new data.

In a general deep learning process, parameters may be initialized first and hyperparameters may be defined. The parameters refer to values, which can be calculated through data, and serve as variables determined inside the artificial intelligence learning model. The hyperparameters refer to values that an algorithm user directly set based on experience. The hyperparameters may vary depending on the learning model or data without having set optimal values.

Next, learning may be repeated a preset number of times. When the learning process proceeds, first, the learning may be sequentially propagated forward through the artificial neural network. Next, a loss function may be calculated. The loss function refers to a function that calculates a difference between an expected value according to input and an actual value. Next, it may be propagated backward through the artificial neural network. Next, the parameters may be updated. A learned model may be generated by repeating the above process a set number of times.

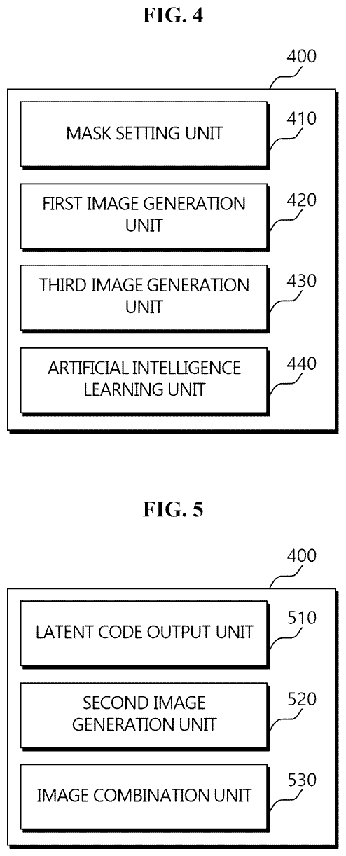

FIG. 4 is a view showing the configuration of the apparatus for learning an artificial intelligence learning model for image reconstruction according to one embodiment of the present invention.

Referring to FIG. 4, an apparatus 400 for learning an artificial intelligence learning model for image reconstruction according to one embodiment of the present invention may include: a mask setting unit 410 for setting masks for a plurality of parts of an original image; a first image generation unit 420 for generating a first image corresponding to a first part among the parts; a third image generation unit 430 for generating a third image by applying a mask for the first part to the first image; and an artificial intelligence learning unit 440 for training the artificial intelligence learning model.

The mask setting unit may set a mask area corresponding to each of a plurality of preset parts of the original image, the first image generation unit may generate a first image corresponding to a first part among the parts based on an artificial intelligence learning model for generating a reconstructed image, the third image generation unit may generate a third image by applying a mask for the first part to the first image, and the artificial intelligence learning unit may perform learning on an artificial intelligence learning model for outputting a latent code corresponding to the first part by calculating a loss function corresponding to a difference between the original image and the third image and performing back-propagation based on the loss function.

The artificial intelligence learning model for outputting a latent code may be a first artificial intelligence learning model that receives the original image as input to output a latent code for generating a reconstructed image corresponding to at least one of the parts, and the artificial intelligence learning model for generating a reconstructed image may be a second artificial intelligence learning model that receives the latent code as input to output a reconstructed image.

In addition, the mask setting unit may expand and set an area for each of the masks so that boundaries subject to division of the original image overlap with each other, and may blur each of the masks to allow areas, which overlap when the first image is combined according to the expansion, to be naturally combined.

FIG. 5 is a view showing the configuration of the apparatus for learning an artificial intelligence learning model for image reconstruction according to one embodiment of the present invention.

Referring to FIG. 5, the apparatus 400 for learning an artificial intelligence learning model for image reconstruction according to one embodiment of the present invention may further include: a latent code output unit 510 for outputting a latent code from the original image; a second image generation unit 520 for generating images reconstructed from the latent code; and an image combination unit 530 for combining the reconstructed images.

The latent code output unit may output a latent code for generating a first image reconstructed for each of the parts from the original image based on the first artificial intelligence learning model, the second image generation unit may generate the first images reconstructed from the latent code for each of the parts based on the second artificial intelligence learning model, and the image combination unit may generate a second image reconstructed with respect to the original image by applying the mask to each of the first images generated for each of the parts, and combining the first images to which the mask is applied.

The first artificial intelligence learning model may include a plurality of artificial intelligence learning models that output latent codes for generating reconstructed images for each of the parts.

In addition, the artificial intelligence learning unit may repeatedly learn until a loss value corresponding to a difference between the original image and the first images is decreased to a preset value or less, and the second image generation unit may generate the first images for each of the parts by adjusting style values for image reconstruction for each of the parts with respect to the original image.

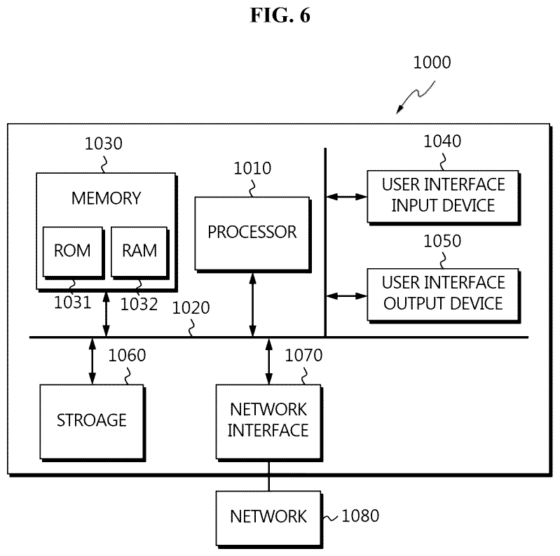

FIG. 6 is a view showing a computer system according to one embodiment of the present invention.

The apparatus for learning an artificial intelligence learning model for image reconstruction according to one embodiment of the present invention may be implemented in a computer system 1000 such as a computer-readable recording medium.

Referring to FIG. 6, the computer system 1000 may include at least one processor 1010, memory 1030, user interface input device 1040, user interface output device 1050, and storage 1060 that communicate with each other via a bus 1020. In addition, the computer system 1000 may further include a network interface 1070 connected to network 1080. The processor 1010 may be a central processing unit or a semiconductor device that executes processing instructions stored in the memory 1030 or the storage 1060. The memory 1030 and the storage 1060 may include various forms of volatile or non-volatile storage media. For example, the memory may include ROM 1031 or RAM 1032.

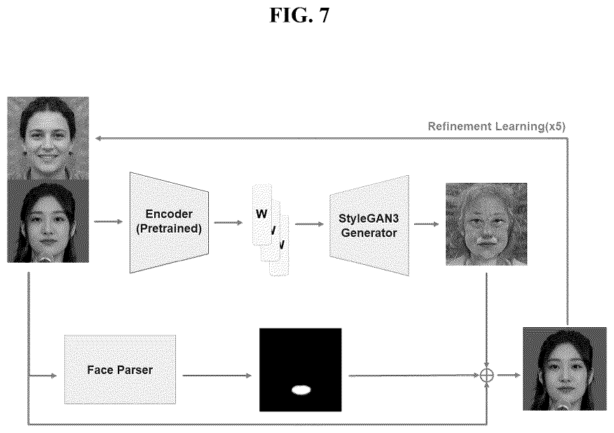

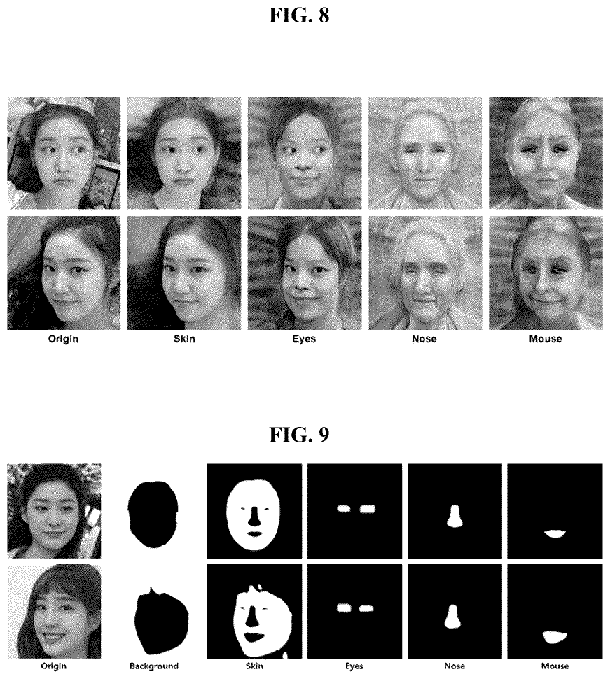

FIG. 7 is a view showing a learning process of an artificial intelligence learning model for a specific part according to one embodiment of the present invention.

Referring to FIG. 7, in the learning process of the artificial intelligence learning model for a specific part according to one embodiment of the present invention, a latent code corresponding to the original image may be output through a pre-trained encoder, and an image may be output using a StyleGAN generator. After the output image is combined with a mask for the specific part, only the image of the corresponding part remains, and the remaining part is replaced with the original image so that a reconstructed image may be output. Gaussian Blur may be applied for more natural combination. The encoder may perform learning on the specific part by using the reconstructed image.

A pre-trained encoder may learn by using the mask for the specific part. Since a learning scope is limited to the mask, the area corresponding to the mask may be output more similarly to the original, and the other areas may output completely unrelated results. A plurality of encoders may be trained for a plurality of parts, respectively. Reconstructed images for each part may be output through the encoders, and the reconstructed images for each part may be combined, so that a reconstructed image of the original image may be output.

When the reconstructed images for each part are combined, the boundary areas of the masks are required to be naturally combined, which may be defined as having no artificial artifacts and achieving similarity of 70% or more for the boundary area between the real image and the synthetic image.

FIG. 8 is a view showing images output from the model learned by applying learning for each part according to one embodiment of the present invention.

Referring to FIG. 8, In the image output from the model learned by applying learning for each part according to one embodiment of the present invention may be generated as an image completely different from the original image for the unlearned area, and high quality results may be generated for the learned area.

FIG. 9 is a view showing results of generating masks for a plurality of parts according to one embodiment of the present invention.

Referring to FIG. 9, a goal of the mask may be to allow the encoder to have as much information as possible to reconstruct after learning. When the mask is divide for the above goal, the mask is required to be divided according to a standard that may not be changed with respect to the image, and the original image may be divided as much as possible while still having meaning in which a part having pairs may be regarded as an exception and accordingly may not be divided. According to one embodiment of the present invention, masks may be generated for five areas, such as background, skin, eyes, nose, and mouth parts. Accordingly, the original image containing the face may be divided into the five area, masks (Mⁱ) corresponding to the parts, respectively.

An input image P(x) may be represented by the sum of the generated masks.

$$P ( x ) = {\sum }_{i = 0}^{k} {M}^{i}$$

According to one embodiment, in the method of outputting the reconstructed image using the masks, a learning model E_{base} serving as a basis for all learning may be defined first.

Herein, E_{base} may include pSp, e4e and Restyle, and a decoder may include StyleGAN3.

Next, additional learning may be performed because the original image in high quality cannot be expressed from StyleGAN3 with only information which E_{base c}an obtain from the original image. Parameters and learning process of the additional learning may be performed the same as the learning process of E_{base}, and images generated by combining different masks with an output image may be different from each other. A learning model (E_{seg}ⁱ) for each part may be generated through the additional learning.

Next, the learning model (E_{seg}ⁱ) for each part may output a reconstructed image using the original image as input, and replace the mask (Mⁱ) corresponding to the learning model for each part with the original image. The output of the learning model for each part may be expressed in the following equation.

$${\hat{y}}_{seg}^{oi} = G ( {E}_{seg}^{i} ( x ) ) * {M}^{i} + x * ( 1 - {M}^{i} )$$

x denotes an original image G denotes a generator, E_{seg}ⁱ denotes an encoder corresponding to the i-th part, and ŷ_{seg}ⁱ denotes an image output corresponding to the i-th part. A reconstructed image (ŷ) that may be generated by combining outputs of a total of k learning models for each part may be expressed in the following equation.

$$\hat{y} = {\sum }_{i = 0}^{k} G ( {E}_{seg}^{i} ) * {M}^{i}$$

According to one embodiment, when learning on the encoder proceeds, the learning may be performed using schemes including pSp, e4e and Restyle. A latent code that approximates a W space may be generated by using an L2 loss function for reducing loss in image reconstruction at a pixel level, and an LPIPS loss function for perceptual reconstruction loss. For e4e, a w_regularization loss function may be additionally used.

$${L}_{Encoder} = {λ}_{L 2} {L}_{L 2} + {λ}_{LPIPS} {L}_{LPIPS}$$

When the original image is reconstructed, preserving core information of the face is very important in GAN Inversion. Accordingly, a given face may be encoded using an additive angular margin loss function (ArcFace), and cosine similarity between the original image and the output image may be compared. Unlike being commonly used, all results according to the resolution mentioned in a baseline may be used, so that a loss function using all five feature maps including output layers may be calculated. Five different levels of function may be selected as a supervisor to better supervise the semantic alignment of identification information between the reconstructed image and the original image according to the resolution size.

$${L}_{id} = \frac{{\sum }_{i = 1}^{5} 1 - cos ( {R}_{j} ( x ) - {R}_{i} ( G ( {E}_{seg}^{j} ( x ) ) ) )}{l}$$

Herein, cos denotes cosine similarity, and Rᵢ(x) may represent the feature corresponding to the i-th layer in a face recognition network R of an input image x. Finally, the loss function for encoder learning may be expressed in the following equation.

$$L = {λ}_{Encoder} {L}_{Encoder} + {λ}_{id} {L}_{id}$$

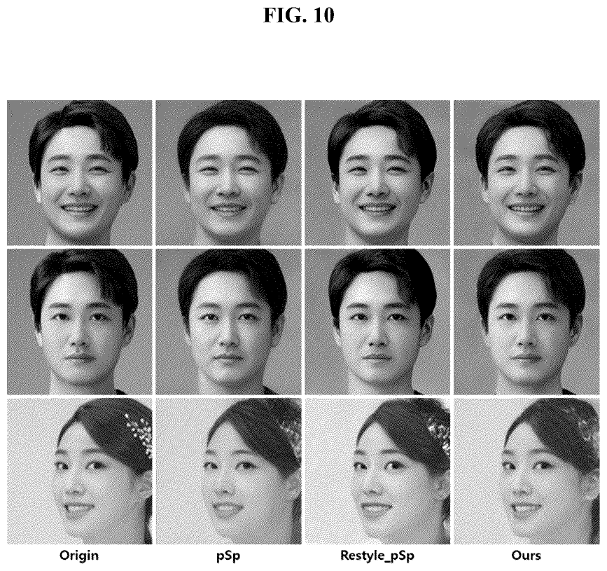

FIGS. 10 to 19 are views showing experimental processes and experimental results of generating images reconstructed using an encoder and StyleGAN. In the experiments, the Encoder Backbone is the SE-ResNet50 Backbone used by Restyle, and the StyleGAN3-config-R model pre-trained with the FFHQ Dataset is used as a generator. Among the loss functions, Alex is used for the LPIPS loss function and ArcFace is used for the Id loss function. Learning of the encoder is also performed with the FFHQ Dataset like the generator, the evaluation uses the CelebA-HQ Dataset, and 10, 50 or 100 random images are selected and processed as subjects.

FIG. 10 is a view showing images output based on original images and an encoder.

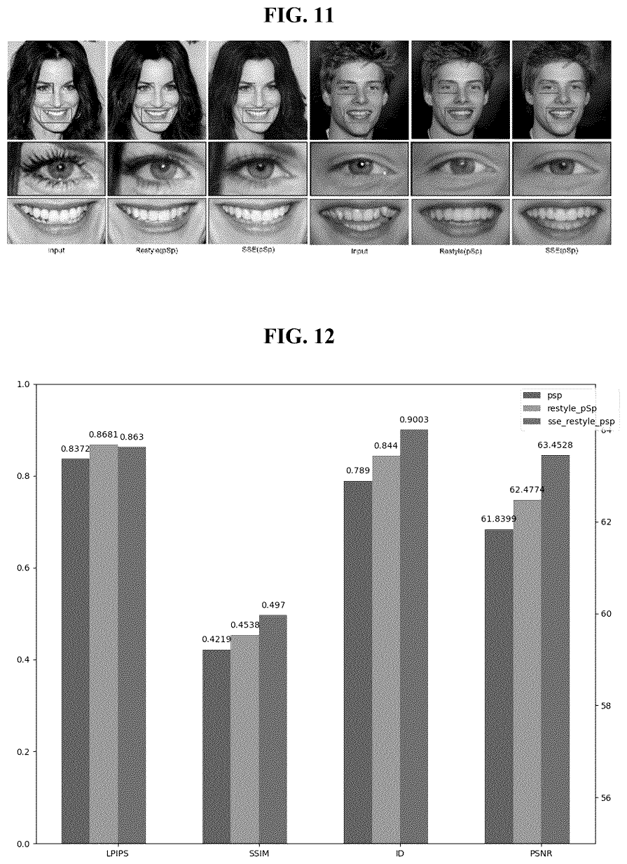

FIG. 11 is a view showing enlarged detailed areas of original images and output images.

Referring to FIGS. 10 and 11, the encoder method (SSE) according to the present invention and schemes, such as pSp and Restyle, used in existing encoders may be qualitatively compared.

The encoder method according to the present invention may reconstruct more accurate colors and overall impressions when compared to pSp and Restyle,.

In addition, detailed information such as eye position, teeth or the like in a face area may be configured more accurately and in detail than the Restyle scheme.

In the first row of FIG. 11, it can be seen that the input image and the SSE image of a person on the left have gazes directed forward, however, the gaze of Restyle is directed to the right. In an image, a person's gaze is very important information and a completely different perspective may be created even by a slight pixel difference. The encoder method according to the present invention may generate an image having a distortion-free gaze by high reconstruction performance in detailed areas. The second row has images enlarged of eyes in the first row. Overall, the encoder method according to the present invention may generate significantly similar images, such as detailed eye shape, distance from pupil to eye border, and eyelashes, compared to Restyle. As can be seen in the third row for a person on the right, the overall shape of Restyle's mouth is flat, however, The encoder method according to the present invention may generate a more curved mouth shape. In the detailed areas as above, the encoder method according to the present invention may exhibit higher accuracy compared to Restyle.

FIG. 12 is a chart showing results of measuring 10 random sheets of the Celeba Dataset.

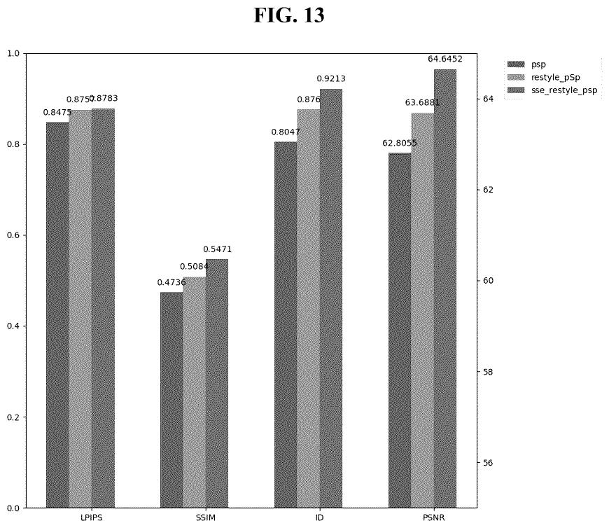

FIG. 13 is a chart showing results of measuring 50 random sheets of the Celeba Dataset.

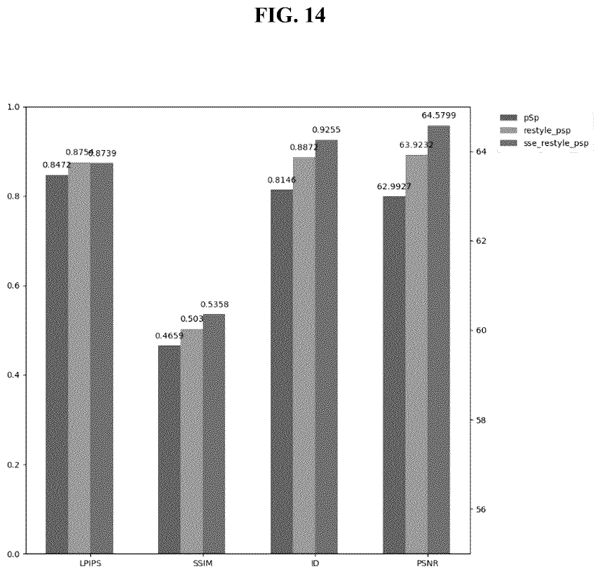

FIG. 14 is a chart showing results of measuring 100 random sheets of the Celeba Dataset.

Referring to FIGS. 12 to 14, the encoder method SSE according to the present invention may be quantitatively compare with the schemes used in the existing encoders such as pSp and Restyle. Structural similarity index map (SSIM), peak signal-to-noise ratio (PSNR) score, LPIPS distance, and ID may be calculated with respect to methods used in the encoders, respectively.

As shown in FIGS. 12 to 14, the encoder method SSE according to the present invention may achieve indices in the SSIM, PSNR and ID higher than pSp and Restyle-pSp, excluding the LPIPS distance. The LPIPS is also measured higher in FIG. 13, and the remaining results are indicated similar. The above analysis proves that the encoder method SSE according to the present invention has reconstruction performance higher than that of Restyle. Performance of StyleGAN3 Inversion is deteriorated by about 10% compared to StyleGAN2 Inversion. It can be seen as a very positive result in that high indices are achieved by overcoming the above deterioration. Meanwhile, because multiple models are used for one inference, it has the disadvantage of using more costs compared to other encoder-based schemes.

TABLE 1

| | SSIM↑ | PSNR↑ | LPIPS↓ | ID | Runtime(s) |
|---|---|---|---|---|---|
| pSp | 0.42 | 61.84 | 0.16 | 0.79 | 0.17 s |
| Restyle(pSp) | 0.45 | 62.48 | 0.13 | 0.84 | 0.75 s |
| SSE(SG3) | 0.50 | 63.45 | 0.14 | 0.90 | 2.24 s |

Referring to FIG. 12 and Table 1, Table 1 shows the results obtained by measuring 10 random sheets of the Celeba Dataset. When the encoder method (SSE) according to the present invention is compared with Restyle_pSp (SG2), SSIM, PSNR and ID exhibit better performance and LPIPS has lower performance. FIG. 12 is a view graphically showing Table 1.

TABLE 2

| | SSIM↑ | PSNR↑ | LPIPS↓ | ID | Runtime(s) |
|---|---|---|---|---|---|
| pSp | 0.47 | 62.81 | 0.15 | 0.80 | 0.16 s |
| Restyle(pSp) | 0.51 | 63.69 | 0.12 | 0.88 | 0.75 s |
| SSE(SG3) | 0.55 | 64.65 | 0.12 | 0.92 | 2.24 s |

Referring to FIG. 13 and Table 2, Table 2 shows the results obtained by measuring 50 random sheets of the Celeba Dataset. Restyle uses StyleGAN2 as a generator. The encoder method SSE according to the present invention shows higher performance than Restyle in most cases. FIG. 13 is a view graphically showing Table 2.

TABLE 3

| | SSIM↑ | PSNR↑ | LPIPS↓ | ID | Runtime(s) |
|---|---|---|---|---|---|
| pSp | 0.47 | 62.99 | 0.15 | 0.81 | 0.16 s |
| Restyle(pSp) | 0.50 | 63.92 | 0.12 | 0.89 | 0.74 s |
| SSE(SG3) | 0.54 | 64.58 | 0.13 | 0.93 | 2.24 s |

Referring to FIG. 14 and Table 3, Table 3 shows the results obtained by measuring 100 random sheets of the Celeba Dataset. When the encoder method (SSE) according to the present invention is compared with Restyle_pSp (SG2), SSIM, PSNR and ID exhibit better performance and LPIPS has lower performance. FIG. 14 is a view graphically showing Table 3.

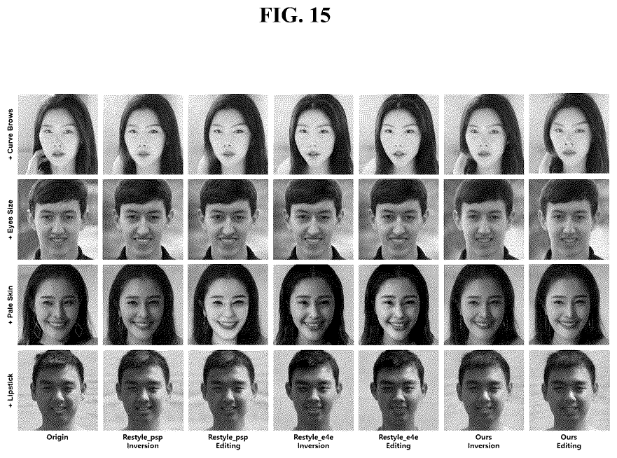

FIG. 15 is a view showing edited images output according to the editing schemes applied to the encoder.

Referring to FIG. 15, editing performance may be evaluated qualitatively.

Editing of the original image is compared with the Restyle-pSp and Restyle-e4e models that respectively use StyleGAN3 as the decoder, and the comparison group is subject to the weight of the charm. The same attribute is applied to the same channel by using StyleSpace editing but different values are applied depending on models. As shown the third row of FIG. 15, in the case of Restyle-pSp, editing may harm the contrast of the face. In the case of Restyle-e4e, the edited images fail to sufficiently preserve the attributes of the original image due to the overall low reconstruction performance, however, editing proceeds correctly in the reconstructed image. However, the Straight Brow attribute in the first row is not noticeably applied. It can be seen that the encoder method SSE according to the present invention has the reconstruction performance remarkably superior compared to the comparison group, and the editing performance also allows editing while preserving the existing attributes. Accordingly, the reconstruction performance can be improved and the editing performance can also be improved.

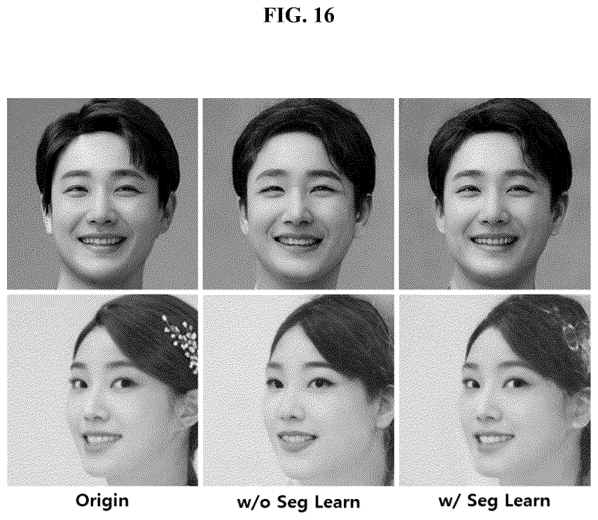

FIG. 16 is a view showing images output through Restyle pSp that uses StyleGAN3 as a decoder.

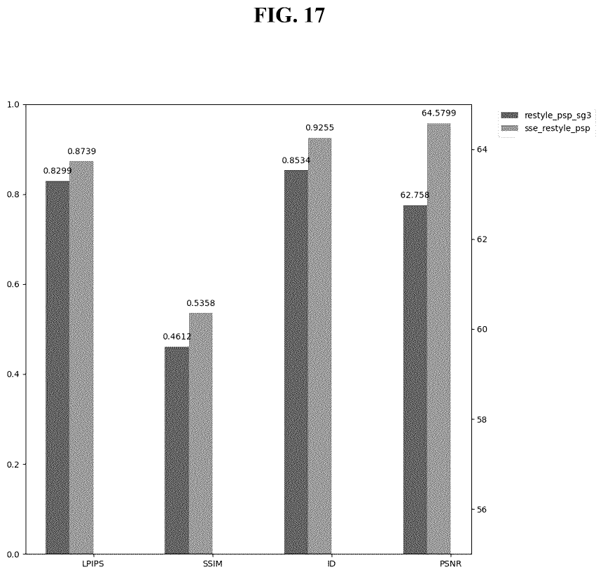

FIG. 17 is a chart showing reconstruction results of Restyle_pSp using the same decoder StyleGAN3 and reconstruction results according to the present invention with targeting 100random sheets of Celeba Dataset.

Referring to FIGS. 16 and 17, first, the cases without and with segment learning are compared in order to verify the encoder method (SSE) according to the present invention. The segment learning refers to dividing the original image into a plurality of parts and learning each of the parts. In FIG. 16, it can be seen that the reconstruction performance has dramatically improved, and especially remarkable in the pupils and teeth.

It can be seen that the gaze fails to be restored correctly when the segment learning is not used (second column of FIG. 16), however, the gaze is perfectly restored when the segment learning is used (third column of FIG. 16).

TABLE 4

| | SSIM↑ | PSNR↑ | LPIPS↓ | ID↑ | Runtime(s) |
|---|---|---|---|---|---|
| Restyle- | 0.46 | 62.76 | 0.17 | 0.85 | 0.70 s |
| pSp(SG3) | | | | | |
| SSE(SG3) | 0.54 | 64.58 | 0.13 | 0.93 | 2.23 s |

Referring to FIG. 17 and Table 4, reconstruction results of Restyle_pSp using the same decoder StyleGAN3 and Table 4 shows the comparison between reconstruction results of the encoder method SSE according to the present invention. According to the encoder method SSE according to the present invention, it can be seen that all quantitative indices are also significantly increased in four areas, that is, LPIPS, ID, PSNR and SSIM, and thus, the segment learning is very helpful in improving the performance of the encoder. FIG. 17 is a view graphically showing Table 4.

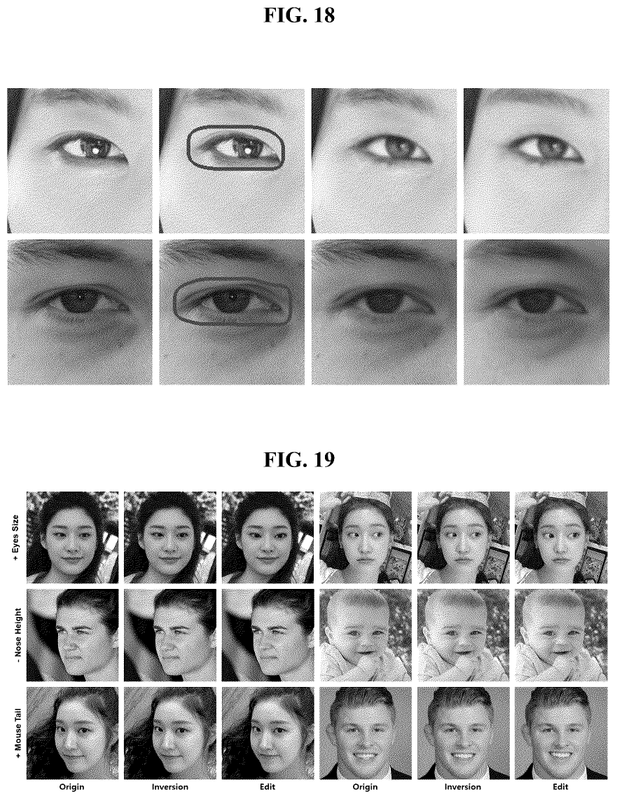

FIG. 18 is a view showing original images, synthetic images, and results of combination thereof.

Referring to FIG. 18, the first column shows original images, the second column shows images indicating boundaries of synthetic areas in the original images, the third column shows combined images between the original image and the synthetic image, and the fourth column shows images generated through combination between synthetic images. As shown in the above experiment results, the output generated by a sufficiently learned model using the encoder method SSE according to the present invention has no visible artifacts occurring when mask areas are exchanged with original images. For more detailed analysis, a check may be performed on whether the prerequisites are satisfied.

First, the first prerequisite is “whether the synthetic image is combined with the original image without generating a boundary”. This may be confirmed by combining the synthetic image and the original image. First, in a qualitative aspect, the synthetic images do not generate visible boundaries as can be seen in the third column of FIG. 18. In addition, in a quantitative aspect, the encoder method SSE according to the present invention shows the best performance and produces excellent results with a difference much larger than differences of Restyle-pSp (SG3) and Restyle-pSp (SG2). This shows that the segment learning is specialized for mask boundaries to induce natural combination when considering that the simple reconstruction performance difference is larger between Restyle-pSp (SG3) and Restyle-pSp (SG2).

The second prerequisite is “whether different synthetic images are combined without generating boundaries”. This may be confirmed through combination between the synthetic images. As shown in the fourth column of FIG. 18, no visible boundary line is generated. The learning models for each segment, which is trained to reconstruct an image more closely to the original image compared to the previous learning, may combine images without particular artifacts even when combining different outputs. This proves that a sufficiently natural image can be generated even by a simple BitMask operation without special image synthesis logic, and the input image can be reconstructed with a very high degree of similarity.

FIG. 19 is a view showing original images and edited images.

Referring to FIG. 19, the encoder method SSE according to the present invention may reconstruct and edit only the desired specific part rather than simply reconstruct an entire one piece of image. This is because the above process allows natural combinations without generating visible boundaries even when only the specific part is exchanged. When viewed in FIG. 19, the attributes are maintained even after editing. However, editing significantly changing a color of the boundary area may be required to use special editing techniques.

The specific implementations described in the present invention are merely examples and do not limit the scope of the present invention in any manner. For clarity of the specification, the description of conventional electronic components, control systems, software, and other functional aspects of the above systems may be omitted. In addition, the connections or connecting members of lines between the components shown in the drawings exemplify functional connections and/or physical or circuit-wise connections, and alternative or additional various functional connections, physical connections, or circuit-wise connections may be embodied in actual devices. In addition, the corresponding component may not be required for application of the present invention, unless specifically stated as “essential”, “important”, or the like.

Accordingly, the spirit of the present invention will not be limited to the embodiments described above, and the claims described below and all ranges equivalent to or modified from the claims will fall within the scope of the spirit of the present invention.

What is claimed is:

1. A method for learning an artificial intelligence learning model for image reconstruction, the method comprising:
setting a mask area corresponding to each of a plurality of preset parts to an original image;
based on an artificial intelligence learning model for generating a reconstructed image,
generating a first image corresponding to a first part among the parts;
generating a third image by applying a mask for the first part to the first image;
calculating a loss function corresponding to a difference between the original image and the third image; and
performing learning on an artificial intelligence learning model for outputting a latent code corresponding to the first part by performing back-propagation based on the loss function, wherein
the artificial intelligence learning model for outputting a latent code includes a first artificial intelligence learning model that receives the original image as input to output a latent code for generating a reconstructed image corresponding to at least one of the parts, and
the artificial intelligence learning model for generating a reconstructed image includes a second artificial intelligence learning model that receives the latent code as input to output a reconstructed image.

2. The method of claim 1, wherein the setting of the mask area includes:
expanding and setting an area for each of the masks so that boundaries subject to division of the original image overlap with each other; and
blurring each of the masks to allow areas, which overlap when the first image is combined according to the expansion, to be naturally combined.

3. The method of claim 2, further comprising:
outputting a latent code for generating a first image reconstructed for each of the parts from the original image based on the first artificial intelligence learning model after the setting of the mask area:
generating the first images reconstructed from the latent code for each of the parts based on the second artificial intelligence learning model; and
generating a second image reconstructed with respect to the original image by applying the mask to each of the first images generated for each of the parts and combining the first images to which the mask is applied.

4. The method of claim 3, wherein the first artificial intelligence learning model includes a plurality of artificial intelligence learning models that output latent codes for generating reconstructed images for each of the parts, and
the outputting of the latent code, the generating of the first images, and the performing of the learning on the artificial intelligence learning model are repeatedly until a loss value corresponding to a difference between the original image and the first images is decreased to a preset value or less.

5. The method of claim 4, wherein the generating of the first images includes generating the first images for each of the parts by adjusting style values for image reconstruction for each of the parts with respect to the original image.

6. An apparatus for learning an artificial intelligence learning model for image reconstruction, the apparatus comprising:
a mask setting unit for setting masks for a plurality of parts of an original image:
a first image generation unit for generating a first image corresponding to a first part among the parts:
a third image generation unit for generating a third image by applying a mask for the first part to the first image; and
an artificial intelligence learning unit for training the artificial intelligence learning model.

7. The apparatus of claim 6, wherein the mask setting unit sets a mask area corresponding to each of a plurality of preset parts of the original image,
the first image generation unit generates a first image corresponding to a first part among the parts based on an artificial intelligence learning model for generating a reconstructed image,
the third image generation unit generates a third image by applying a mask for the first part to the first image,
the artificial intelligence learning unit performs learning on an artificial intelligence learning model for outputting a latent code corresponding to the first part by calculating a loss function corresponding to a difference between the original image and the third image and performing back-propagation based on the loss function,
the artificial intelligence learning model for outputting a latent code includes a first artificial intelligence learning model that receives the original image as input to output a latent code for generating a reconstructed image corresponding to at least one of the parts, and
the artificial intelligence learning model for generating a reconstructed image includes a second artificial intelligence learning model that receives the latent code as input to output a reconstructed image.

8. The apparatus of claim 7, wherein the mask setting unit expands and sets an area for each of the masks so that boundaries subject to division of the original image overlap with each other, and blurs each of the masks to allow areas, which overlap when the first image is combined according to the expansion, to be naturally combined.

9. The apparatus of claim 8, further comprising:
a latent code output unit for outputting a latent code from the original image:
a second image generation unit for generating images reconstructed from the latent code; and
an image combination unit for combining the reconstructed images, wherein
the latent code output unit outputs a latent code for generating a first image reconstructed for each of the parts from the original image based on the first artificial intelligence learning model,
the second image generation unit generates the first images reconstructed from the latent code for each of the parts based on the second artificial intelligence learning model, and
the image combination unit generates a second image reconstructed with respect to the original image by applying the mask to each of the first images generated for each of the parts and combining the first images to which the mask is applied.

10. The apparatus of claim 9, wherein the first artificial intelligence learning model includes a plurality of artificial intelligence learning models that output latent codes for generating reconstructed images for each of the parts,
the artificial intelligence learning unit repeatedly learns until a loss value corresponding to a difference between the original image and the first images is decreased to a preset value or less, and
the second image generation unit generates the first images for each of the parts by adjusting style values for image reconstruction for each of the parts with respect to the original image.
